(19) United States
(12) Patent Application Publication
(10) Pub. No.: US 2017/0300807 A1
(43) Pub. Date: Oct. 19, 2017

(54) NEURAL NET COMPUTER SYSTEM WITH WIRELESS OR OPTICAL CONNECTIONS BETWEEN NEURAL NET COMPUTING NODES

(71) Applicant: Aivitae LLC, Los Altos, CA (US)

(72) Inventors: Bob Sueh-chien HU, Los Altos Hills, CA (US); Ada Shuk-Yan POON, Redwood City, CA (US)

(21) Appl. No.: 15/495,633

(22) Filed: Apr. 24, 2017

Related U.S. Application Data
(60) Provisional application No. 62/298,403, filed on Feb. 22, 2016.

(51) Int. Cl. G06N 3/04; G06N 3/067

(52) U.S. Cl. CPC G06N 3/04; G06N 3/067

(57) ABSTRACT

In certain embodiments, a neural net computer system may include a plurality of computing nodes. At least some of the computing nodes are associated with a first layer of a neural net. At least some of the computing nodes are associated with a second layer of the neural net. The computing nodes may each include (i) one or more processors, (ii) memory, and (iii) a wireless or optical communication unit. For each of the computing nodes: (i) the processors, the memory, and the wireless or optical communication unit of the computing node are on-die components of the computing node, and (ii) the processors of the computing node (a) transmit signals to other ones of the computing nodes via the wireless or optical communication unit of the computing node and (b) receive signals from other ones of the computing nodes via the wireless or optical communication unit of the computing node.

This application claims priority to: (1) U.S. Provisional Patent Application Ser. No. 62/298,403, filed on Feb. 22, 2016, entitled, “Improved Neural Net Computer with Wireless RF or Optical Connections,” which is hereby incorporated by reference herein in its entirety.

### FIELD OF THE INVENTION

The invention relates to neural net computer systems, including, for example, neural net computer systems with wireless connections between neural net computing nodes, with optical connections between neural net computing nodes, etc.

### BACKGROUND OF THE INVENTION

Conceptually, neural nets emulate the function of the human brain where a layer of simple computing units is massively connected to the next layer, typically with a large number of one-to-many or many-to-one connections that are then weighted through a variety of biological mechanisms. These may, for example, occur on the order of 10⁴ connectors or other number of connectors. However, typical logic gates are generally not able to drive more than a dozen or so other gates at the output stage. Furthermore, the sheer number of interconnections is problematic using conventional silicon layering. Therefore, conventional large (and very large) neural nets may suffer from connection bottlenecks, and sizable neural nets are typically not available, except on large supercomputing systems. These and other drawbacks exist.

### SUMMARY OF THE INVENTION

Aspects of the invention relate to methods, apparatuses, and/or systems for facilitating wireless or optical communication between neural net computing nodes.

In certain embodiments, a neural net computer system may include a plurality of computing nodes. At least some of the computing nodes are associated with a first layer of a neural net. At least some of the computing nodes are associated with a second layer of the neural net. The computing nodes may each include (i) one or more processors, (ii) memory, and (iii) a wireless or optical communication unit. For each of the computing nodes: (i) the processors, the memory, and the wireless or optical communication unit of the computing node are on-die components of the computing node, and (ii) the processors of the computing node (a) transmit signals to other ones of the computing nodes via the wireless or optical communication unit of the computing node and (b) receive signals from other ones of the computing nodes via the wireless or optical communication unit of the computing node.

In some embodiments, at least computing nodes may be formed on a substrate by, for each of the computing nodes on the substrate, forming one or more processors, memory, and a wireless or optical communication unit on the substrate. One or more wireless or optical cavities may be formed around at least some of the computing nodes on the substrate such that each of the one or more wireless or optical cavities reduces signal attenuation for signals transmitted by at least one transmitting component of each computing node within the wireless or optical cavity. At least some of the computing nodes are configured to be associated with a first layer of a neural net. At least some of the computing nodes are configured to be associated with a second layer of the neural net. For each of the computing nodes, the processors of the computing node are configured to (i) wirelessly or optically transmit signals to other ones of the computing nodes via the wireless or optical communication unit of the computing node and (ii) wirelessly or optically receive signals from other ones of the computing nodes via the wireless or optical communication unit of the computing node.

Various other aspects, features, and advantages of the invention will be apparent through the detailed description of the invention and the drawings attached hereto. It is also to be understood that both the foregoing general description and the following detailed description are exemplary and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 illustrates a conventional topology in a feed forward 2-layer neural net.

FIG. 2 illustrates a neural net with wireless connections between computing nodes of the neural net, in accordance with one or more embodiments.

FIGS. 3A and 3B illustrate a computing node that includes a wireless communication unit and other component(s) of the computing node, in accordance with one or more embodiments.

FIG. 4 illustrates of a fabricated wafer that includes computing nodes configured to communicate with one another via their respective wireless or other communication units, in accordance with one or more embodiments.

FIG. 5 illustrates of a computing structure that includes a wireless (or other) cavity around two or more computing nodes, in accordance with one or more embodiments.

FIG. 6 illustrates a computing structure that includes a wireless cavity around two or more computing nodes, where each of the computing nodes have at least one antenna completely within the wireless cavity and at least one antenna that extends to or beyond an outer surface of the wireless cavity, in accordance with one or more embodiments.

FIG. 7 illustrates of a computer system that includes computing structures with cavity-surrounded computing nodes configured to communicate with other cavity-surrounded computing nodes of other computing structures of the computer system, in accordance with one or more embodiments.

FIGS. 8A-8C illustrate the physical flexibility with respect to neural nets with computing nodes having wireless connections between one another, in accordance with one or more embodiments.

### DETAILED DESCRIPTION OF THE INVENTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other instances, well-known structures and devices are shown in block diagram form in order to avoid unnecessarily obscuring the embodiments of the invention.

As an example, a neural net (also referred to as a neural network) may be based on a large collection of neural units (or artificial neurons) in the form of individual computing nodes. Neural nets may loosely mimic the manner in which a biological brain works (e.g., via large clusters of biological neurons connected by axons). Each neural unit of a neural net may be connected with many other neural units of the neural net. Such connections can be enforcing or inhibitory in their effect on the activation state of connected neural units. In some embodiments, each individual neural unit may have a summation function which combines the values of all its inputs together. In some embodiments, each connection (or the neutral unit itself) may have a threshold function such that the signal must surpass the threshold before it is allowed to propagate to other neural units. In some embodiments, these neural net systems may be self-learning and trained, rather than explicitly programmed, and can perform significantly better in certain areas of problem solving, as compared to traditional computer programs. In some embodiments, neural nets may include multiple layers (e.g., where a signal path traverses from front layers to back layers). In some embodiments, back propagation techniques may be utilized by the neural nets, where forward stimulation is used to reset weights on the “front” neural units. In some embodiments, stimulation and inhibition for neural nets may be more free-flowing, with connections interacting in a more chaotic and complex fashion.

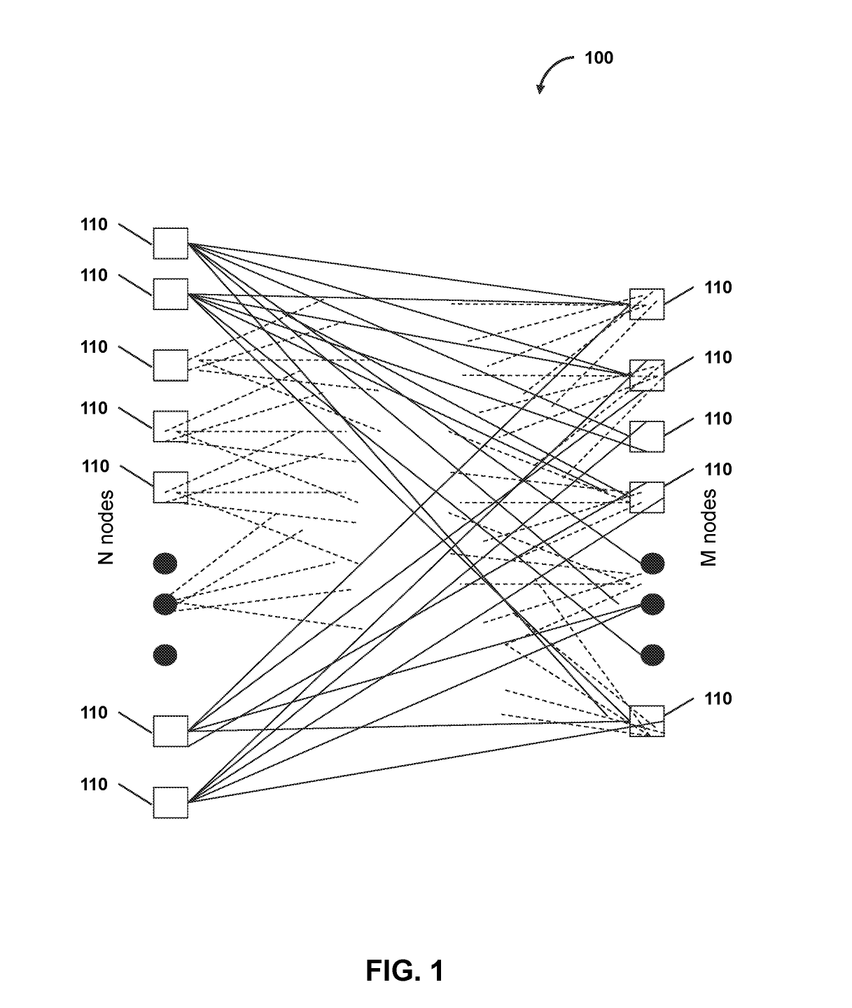

Although neural nets show incredible promise for the field of artificial intelligence and machine learning, a number of drawbacks exist with the conventional implementation of large neural nets that are needed for practical artificial intelligence and machine learning applications. In one use case, with respect to FIG. 1, given n nodes 110 in a first layer of typical feed forward 2-layer neural net 100, and m nodes 110 in a second layer of the typical 2-layer neural net 100, n×m wired connections may exist in the typical 2-layer neural net 100. As the number of nodes (e.g., n nodes, m nodes, etc.) in each layer of a conventional neural net (e.g., the typical 2-layer neural net 100) becomes large, the neural net will likely suffer from connection bottlenecks, and it would not be practical to support the physical size of the neural net in facilitates other than those that have the capacity to support large supercomputing systems.

In some embodiments, a system may include one or more servers, client devices, or other components that interact with one or more neutral nets (or their respective computing nodes). As an example, one or more servers or client devices may interact with a neural net to train the neural net by evaluating outputs of the neural net (e.g., obtained from one or more computing nodes of an output layer of the neural net), providing inputs to the neural net (e.g., initial input, feedback derived from evaluation of the neural net outputs, etc.), or performing other actions with respect to the neural net. In some embodiments, the computing nodes of a neural net may be housed within a single server or client device. In some embodiments, the computing of a neural net may be housed within a collection of servers or client devices.

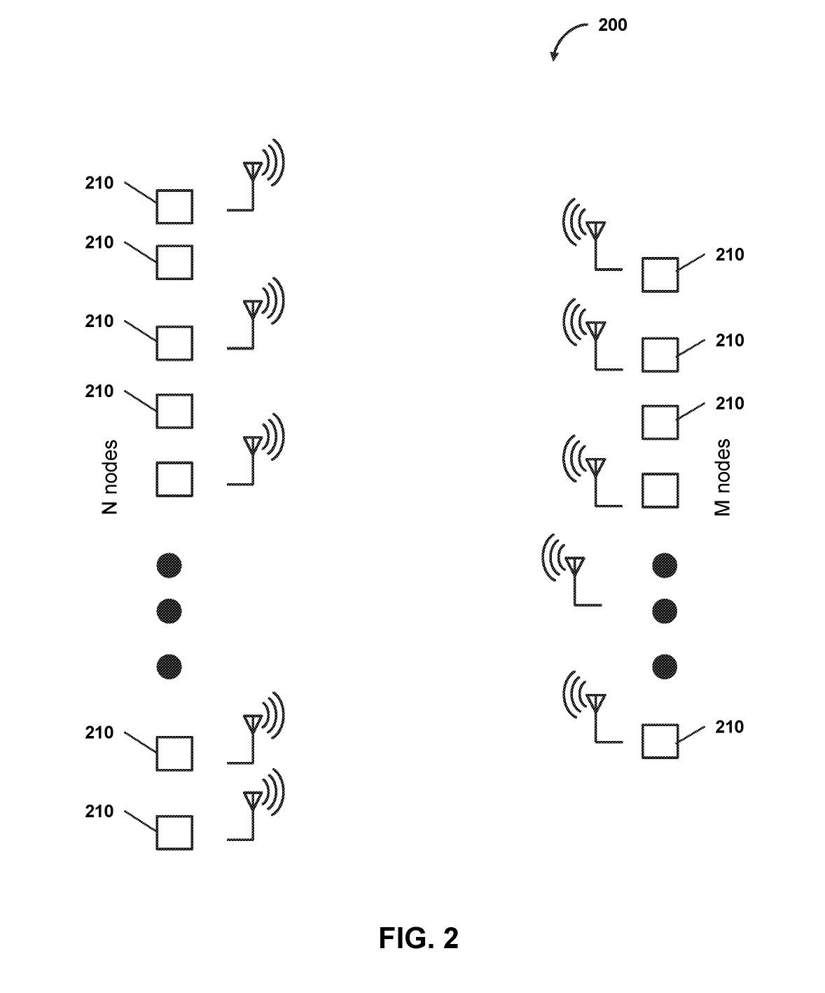

In some embodiments, a neural net may include one or more computing nodes that communicate with one or more other computing nodes (e.g., of the same neural net, of other neural nets, etc.) via their respective wireless connections between the computing nodes and the other computing nodes. In some embodiments, at least some of the computing nodes of the neural net may communicate with at least some of the other computing nodes via their respective optical connections (e.g., in addition to or in lieu of at least some of the wireless connections). As an example, with respect to FIG. 2, each computing node 210 may be a small computing unit suitable for simple calculations performed as part of a neural net. In one use case, the computing nodes 210 may be made with standard or similar technology for integrated circuit (IC) manufacturing. Each computing node 210 may be assigned a unique ID (e.g., for purposes of identifying the origin of a particular signal, for purposes of identifying a destination of a particular signal, etc.). The unique ID assigned to the respective computing node 210 may, for instance, be (i) unique with respect to all other computing nodes of a neutral net, (ii) unique with respect to all other computing nodes of a layer of the neutral net, (iii) unique with respect to all other computing nodes of neural nets used by an organization or other entity, (iv) unique during a given time period, or (v) unique with respect to other criteria. In some embodiments, a neural net may include at least 1,000 computing nodes 210, at least 10,000 computing nodes 210, at least 60,000 computing nodes 210, at least 100,000 computing nodes 210, at least 1,000,0000 computing nodes 210, at least 1,000,000,000 nodes 210, or other number of computing nodes. In one use case, each of the computing nodes 210 of the neural net may have all the same components as one another. In another use case, one or more computing nodes 210 of the neural net may have different components from one or more other computing nodes 210 of the neural net. Given enough bandwidth, multiple layers of a neural net may be constructed virtually using the available spectrum depending on the specific application. In some embodiments, pure feed-forward neural nets may be accommodated with some additional latency by using a single layer of the computing nodes 210 to emulate multiple layers with the available memory.

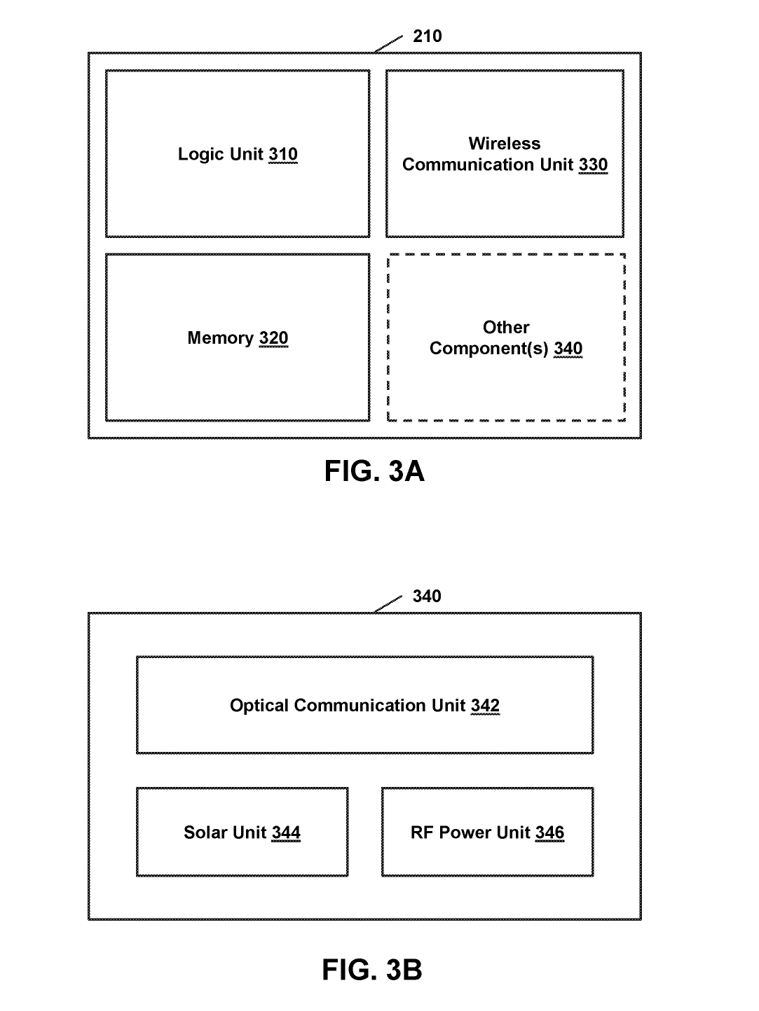

In some embodiments, with respect to FIG. 3A, one or more computing nodes 210 may each include a logic unit 310. The logic unit 310 may include one or more processors. As an example, the processors may be programmed to provide information processing capabilities for the computing nodes 210. The processors may be programmed to execute computer program instructions by software; hardware; firmware; some combination of software, hardware, or firmware; and/or other mechanisms for configuring processing capabilities on the processors. In some embodiments, the computing nodes 210 may each further include a memory 320, a wireless communication unit 330, or other component(s) 340. As an example, the memory 320 may include non-transitory storage media that stores information, such as static random access memory (SRAM), dynamic random access memory (DRAM), Level 1 (L1) cache, Level 2 (L2) cache, etc. The wireless communication unit 330 may include one or more antennas, radio frequency (RF) transceivers, RF receivers, RF transmitters, or other sub-components. As an example, the wireless communication unit 330 of a computing node 210 may be configured to operate at a single predefined frequency range or multiple predefined frequency ranges to enable the computing node 210 to wirelessly communicate with one or more other computing nodes 210 (via their respective wireless communication units 330). In one use case, the predefined frequency ranges (with which the wireless communication units 330 operate) may include ranges within 2.4 GHz and 1.0 THz. Although, in other use cases, the predefined frequency ranges may include frequencies that are less than 2.4 GHz or greater than 1.0 THz. In some use cases, the predefined frequency ranges may include ranges between 60 GHz and 1.0 THz. In some use cases, the predefined frequency ranges may include ranges between 60 GHz and 200 GHz. In some use cases, the predefined frequency ranges may include ranges between 200 GHz and 1.0 THz.

In some embodiments, with respect to FIG. 3B, the other components 340 of a computing node 210 may include an optical communication unit 342, a solar unit 344, a RF power unit 346, or other components. The optical communication unit 342 may include one or more optical transceivers (e.g., laser or other optical transceiver), optical receivers, optical transmitters, or other components (e.g., for processing, transmitting, or receiving information in light beams or pulses along transparent fibers or cables). The solar unit 344 may include one or more solar cells, power storage (e.g., batteries), charge controller, or other sub-components for powering the computing node 210. The RF power unit 346 may include one or more RF power amplifiers, power storage (e.g., batteries), charge controller, or other sub-components for powering the computing node 210.

In some embodiments, with respect to FIGS. 3A and 3B, one or more components of a computing node 210 may be an on-die component (e.g., one or more of the components 310, 320, 330, 342, 344, 346, or other components may be on the same chip). As an example, the logic unit 310, the memory 320, and the wireless communication unit 330 of the computing node 210 may be on the same chip (e.g., at least the three components 310, 320, and 330 are fabricated on the same silicon). As another example, the logic unit 310, the memory 320, and the optical communication unit 342 may be on the same chip (e.g., at least the three components 310, 320, and 342 are fabricated on the same silicon). As yet another example, the logic unit 310, the memory 320, one or both of the wireless communication unit 330 or optical communication unit 342, and one or both of the solar unit 344 or the RF power unit 346 may be on the same chip. In one use case, for example, the components of each computing node of a neural net (or portion thereof) may be fabricated together on the same silicon (e.g., as the processor(s) of the respective computing node) on a large grid and be immediately available for use in forming a neural net.

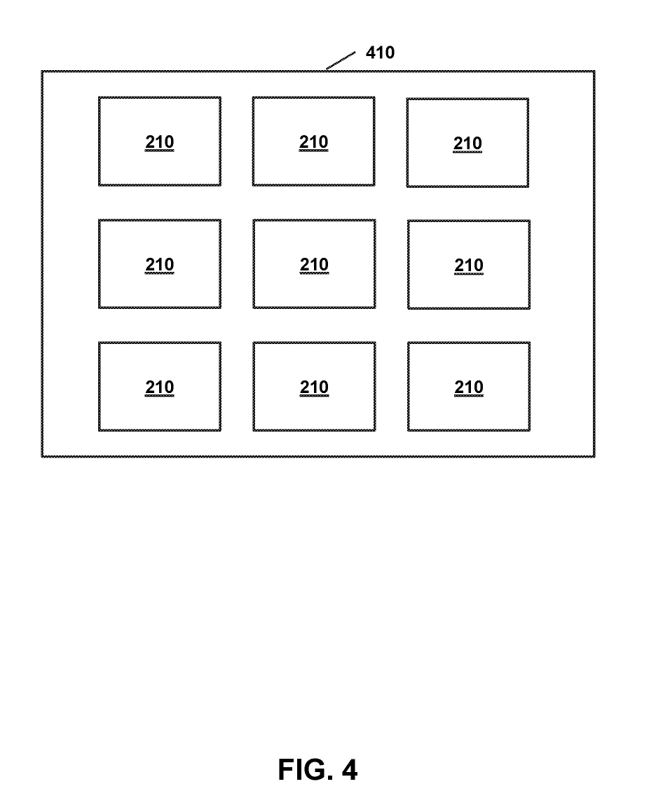

With respect to FIG. 4, for example, multiple computing nodes 210 may be fabricated on the same wafer 410, where each of the computing nodes 210 on the wafer 410 are fabricated to include the same components for each computing node 210. In one scenario, the wireless communication unit of a computing node 210 may be fabricated to be about 1.6 mm in length. It may be fabricated together with the logic unit 310 and the memory 320, and result in the components of the computing node 210 to have a die size being about 2-3 mm. As such, a single 200-300 mm wafer may include about 10,000 computing nodes 210, each of which has its own logic unit 310, memory unit 320, and wireless communication unit 330. In another scenario, given the simplicity of the calculations to be performed by each computing node 210 of a neural net, the logic unit 310 may be further simplified or the memory 320 may be reduced in size. For example, the resulting computing node 210 may be produced on a die size of about 1 mm. As such, a single 200-300 mm wafer may include about 60,000 computing nodes 210. In other scenarios, other sizes of computing nodes may be produced (e.g., computing nodes that are less than 1 mm in one or more dimensions or computing nodes of other sizes).

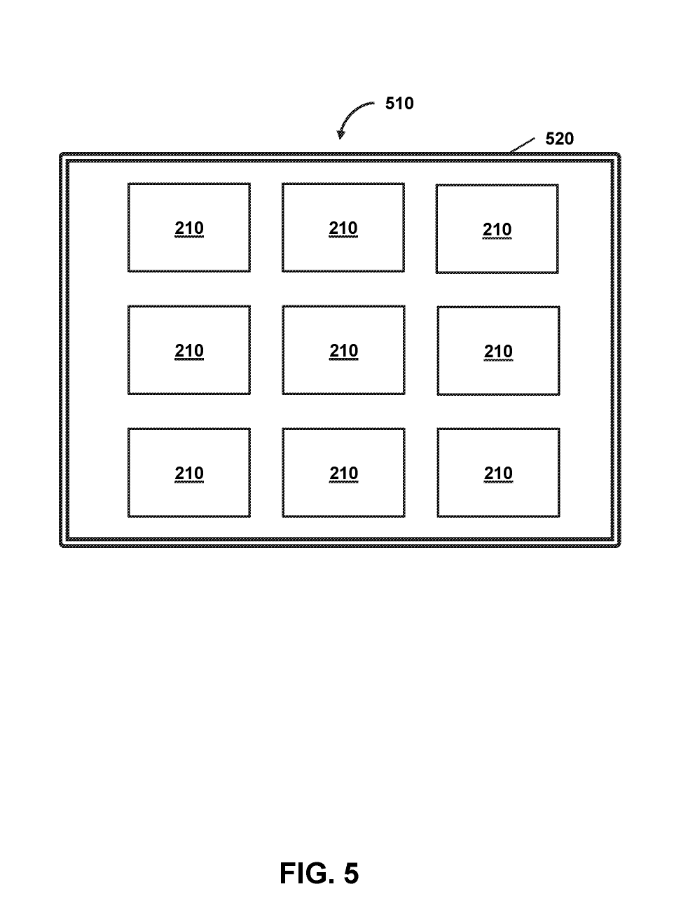

In some embodiments, portions of the wafer may be cut such that each portion of the wafer includes a set of computing nodes 210. In some embodiments, the sets of computing nodes 210 may be physically stacked (e.g., with one set on top of another set) to form a multi-layer neural net. In some embodiments, as discussed herein elsewhere, layers of the multi-layer net may be virtually synthesized (e.g., regardless of the physical arrangement of the computing nodes 210). As discussed, given enough bandwidth, multiple layers can be constructed virtually using the available spectrum depending on the specific application. In some embodiments, with respect to FIG. 5 (which shows a top view of a computing structure 510), the computing structure 510 may be produced by forming a set of computing nodes 210 and placing a cavity 520 around the set of computing nodes 210. As an example, the cavity 520 may be a RF cavity (e.g., formed of aluminum or other metals configured to reflect off RF signals). In one use case, the RF cavity is placed around the set of computing nodes 210 to isolate RF signals transmitted from the computing nodes 210 via their respective antennas that are entirely within the RF cavity. As another example, the cavity 520 may be an optical cavity. In one scenario, the optical cavity is placed around the set of computing nodes to isolate optical signals that are transmitted from the computing nodes via their respective optical transceivers (or transmitters) that are entirely within the optical cavity. In this way, for example, the computing nodes 210 within the cavity 510 may use less power to communicate or more easily communicate with other computing nodes 210 within the cavity 510 (e.g., as compared to without the cavity 510) at least because the cavity 510 will reflect signals transmitted by one computing node 210 to a receiving computing node 210 within the cavity 510.

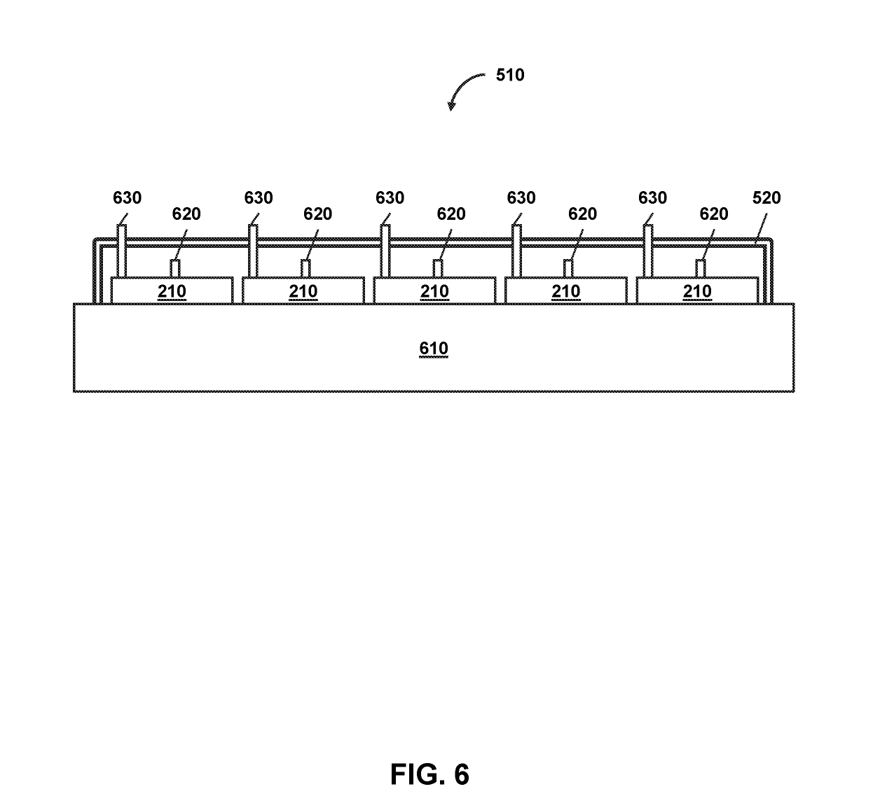

In some embodiments, with respect to FIG. 6 (which shows a front view of the computing structure 510), computing nodes 210 may be formed on silicon 610, and a RF cavity 520 may be formed (or placed) over and around the computing nodes 210. In one scenario, as indicated in FIG. 6, each of the computing nodes 210 may have at least one antenna 620 entirely within the RF cavity 520 and at least one antenna 630 extending to or beyond an outer surface of the RF cavity 520. In some embodiments, each of the computing nodes 210 may be configured to use the same amount of power to transmit signals via the two antennas 620 and 630. In some embodiments, each of the computing nodes 210 may use less power to transmit signals via the antenna 620 (e.g., because the signals will reflect off of the RF cavity 520 and, thus, require less power to effectuate suitable signal transmission), as compared to the amount of power that the computing node 210 uses to transmit signals via the antenna 630 (e.g., because the signals will not reflect off of the RF cavity 520 and are transmitted outside of the RF cavity 520). In this way, for example, the computing nodes 210 may reduce power usage when communicating with other computing nodes 210 within the RF cavity 520 (e.g., as compared to communicating with other computing nodes 210 outside the RF cavity 520). As an example, in one scenario where computing nodes 210 of the same layer of a neural net are within the same RF cavity 520, the computing nodes 210 of the same layer may reduce power usage when communicating with other computing nodes 210 of the same layer (e.g., as compared to communicating with other computing nodes 210 of a different layer of the neural net).

In some embodiments, computing nodes 210 may be formed on silicon 610, and an optical cavity 520 may be formed (or placed) over and around the computing nodes 210. In one scenario, each of the computing nodes 210 may have at least one optical transceiver/transmitter entirely within the optical cavity 520 and at least one optical transceiver/transmitter extending to or beyond an outer surface of the optical cavity 520. In some embodiments, each of the computing nodes 210 may be configured to use the same amount of power to transmit signals via their respective two optical transceivers/transmitters. In some embodiments, each of the computing nodes 210 may use less power to transmit signals via the completely-within-cavity transceiver/transmitter (e.g., because the signals will reflect off of the optical cavity 520 and, thus, require less power to effectuate suitable signal transmission), as compared to the amount of power that the computing node 210 uses to transmit signals via the transceiver/transmitter that extends beyond the optical cavity 520 (e.g., because the signals will not reflect off of the optical cavity 520 and are transmitted outside of the optical cavity 520). As an example, in one scenario where computing nodes 210 of the same layer of a neural net are within the same optical cavity 520, the computing nodes 210 of the same layer may reduce power usage when communicating with other computing nodes 210 of the same layer (e.g., as compared to communicating with other computing nodes 210 of a different layer of the neural net).

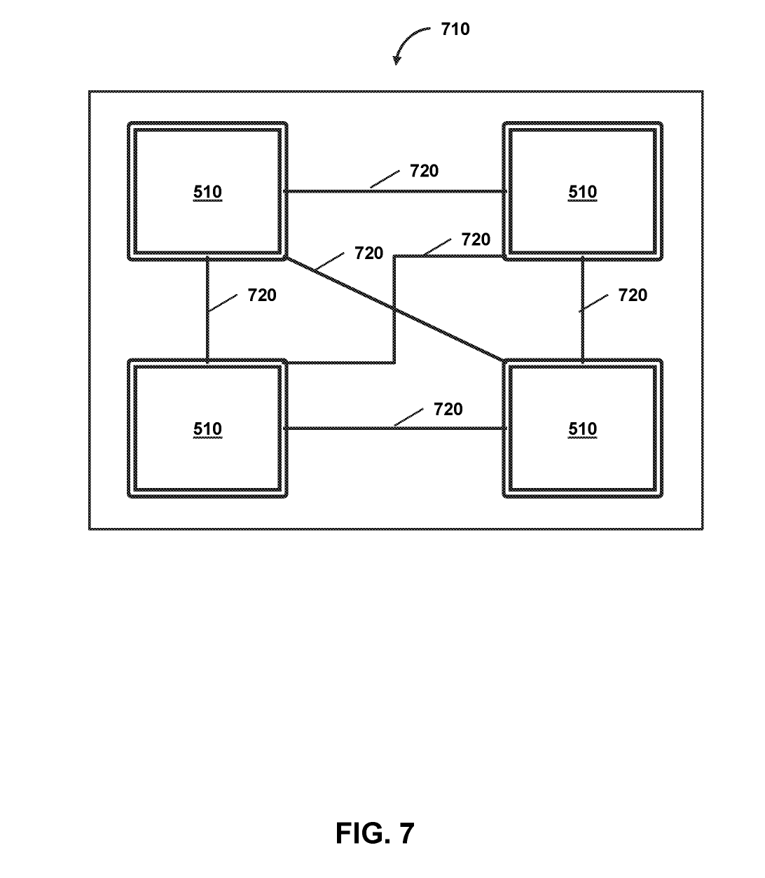

In some embodiments, with respect to FIG. 7, a computing system (e.g., a neural net computer system) may include computing structures 510, where the computing structures 510 each include cavity-surrounded computing nodes 210 configured to communicate with other cavity-surrounded computing nodes of one or more other computing structures 510. As an example, at least one transmitting component (e.g., a wired connector, an antenna, a RF transceiver/transmitter, an optical transceiver/transmitter, etc.) of the computing nodes 210 may extend to or beyond an outer surface of the respective cavity 520 (e.g., which substantially entirely surrounding the portion of the computing nodes 210 not facing the silicon substrate), and the computing node 210 may communicate to other computing nodes 210 outside the cavity 520 via this transmitting component. In some embodiments, the connections 720 between the computing structures 510 include wired connections (e.g., wired metal connections or other wired connections), wireless connections (e.g., RF connections or other wireless connections), optical connections (e.g., glass fiber connections or other optical connections), or other connections.

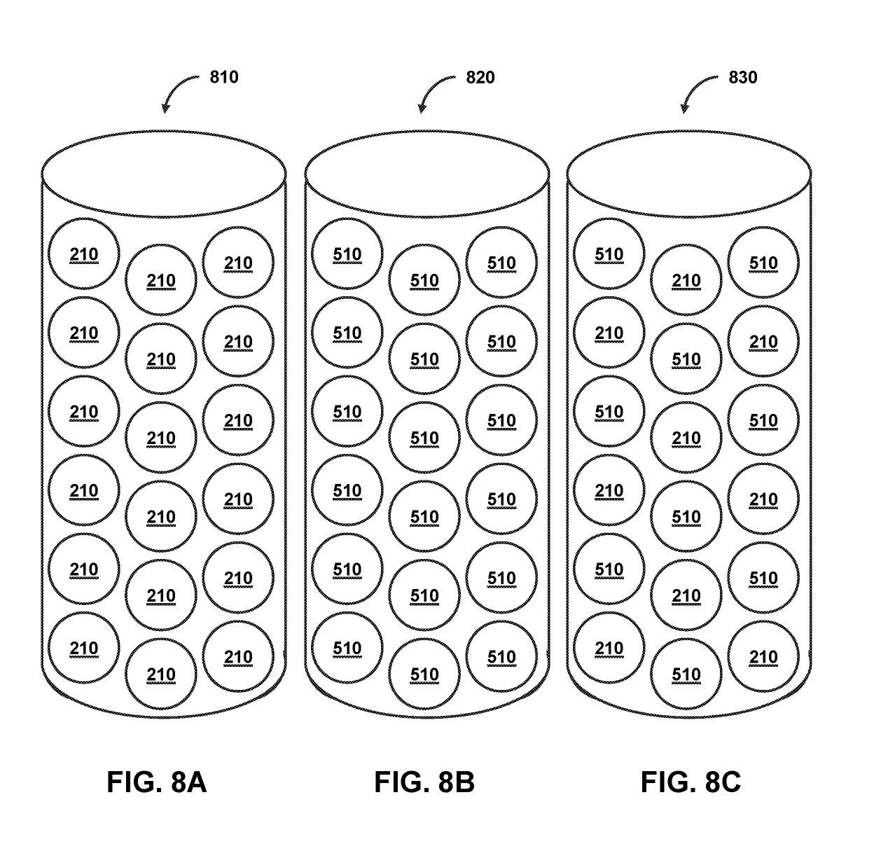

In some embodiments, with respect to FIGS. 8A-8C, a neutral net may include computing nodes 210 having wireless connections between one another. As an example, each computing node 210 of a neural net may be programmed to be associated with a particular layer of a neural net, where a first set of computing nodes 210 may be programmed to be associated with a first layer of the neural net (e.g., an input layer), a second set of computing nodes 210 may be programmed to be associated with a second layer of a neural net (e.g., an output layer), and so on (e.g., one or more other layers, such as layers in between the input and output layers). In one use case, with respect to FIG. 8A, computing nodes 210 (e.g., each of which may be less than 1 mm, about 1 mm, about 1.6 mm each, 2 mm each, or other size in one or more dimensions) of a neural net may be poured into a container structure 810 (e.g., a cup, a jar, or other container structure). Based on their respective programming, the layers of the neural net may be virtually synthesized. As such, the pouring of the computing nodes 210 into the container structure 810 (e.g., without regard to the order that the computing nodes 210 are poured) may not negatively affect the ability of the computing nodes 210 of the respective layers to communicate with one another and operate as a neural net inside the container structure 810. In another use case, the computing structures 510 may be poured into a container structure 820 in which the computing nodes 210 (of the computing structures 510) communicate with one another and operate as a neural net inside the container structure 820. In another use case, a combination of the computing nodes 210 (that are not within a cavity 520) and the computing structures 510 may be poured into a container structure 830 in which the computing nodes 210 communicate with one another and operate as a neural net inside the container structure 830.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The present techniques will be better understood with reference to the following enumerated embodiments:

1. A computer system comprising: a plurality of computing nodes, wherein at least some of the computing nodes are configured to be associated with a first layer of a neural net, and at least some of the computing nodes are associated with a second layer of the neural net, wherein the computing nodes each comprise (i) one or more processors, (ii) memory, and (iii) a wireless or optical communication unit, wherein, for each of the computing nodes: the one or more processors, the memory, and the wireless or optical communication unit of the computing node are on-die components of the computing node, and wherein, for each of the computing nodes, the one or more processors of the computing node (i) wirelessly or optically transmit signals to other ones of the computing nodes via the wireless or optical communication unit of the computing node and (ii) wirelessly or optically receive signals from other ones of the computing nodes via the wireless or optical communication unit of the computing node.
2. The computer system of embodiment 1, further comprising a container, wherein each of the computing nodes is within the container.
3. The computer system of embodiments 1 or 2, further comprising one or more wireless or optical cavities, wherein each of the one or more wireless or optical activities are placed around at least a different subset of the computing nodes, and wherein each of the one or more wireless or optical cavities are configured to reduce signal attenuation for signals transmitted by at least one transmitting component of each computing node within the wireless or optical cavity.
4. The computer system of embodiment 3, wherein, for at least one computing node within each of the one or more wireless or optical cavities, at least one wireless-or-optical-signal transmitting component of the at least one computing node extends beyond an outer surface of the wireless or optical cavity.
5. The computer system of embodiment 4, wherein the one or more processors of the at least one computing node are configured to communicate with the one or more processors of at least one other computing node within at least one other one of the one or more wireless or optical cavities via the at least one wireless-or-optical-signal transmitting component of the at least one computing node that extends beyond the outer surface of the wireless or optical cavity.
6. The computer system of any of embodiments 1-5, wherein, for each of the computing nodes, the one or more processors of the computing node directly transmit signals to other ones of the computing nodes via the wireless or optical communication unit of the computing node without an intermediary between the computing node and the respective other computing node passing the transmitted signal to the respective other computing node.
7. The computer system of any of embodiments 1-6, wherein, for each of the computing nodes, the one or more processors of the computing node directly receive signals from other ones of the computing nodes via the wireless or optical communication unit of the computing node without an intermediary between the computing node and the respective other computing node passing the received signal to the other computing node.
8. The computer system of any of embodiments 1-7, wherein the first layer is an input layer of the neural network, and the second layer is an output layer of the neural network, wherein training information is provided to one or more computing nodes associated with the input layer of the neural net to train the neural net, and wherein one or more results are provided by one or more computing nodes associated with the output layer of the neural net.
9. The computer system of any of embodiments 1-8, wherein the wireless or optical communication unit for each of at least some of the computing nodes comprises a wireless communication unit, the wireless communication unit including a radio frequency transceiver and an antenna.
10. The computer system of any of embodiments 1-9, wherein the wireless or optical communication unit for each of at least some of the computing nodes comprises an optical communication unit, the optical communication unit including an optical transceiver.
11. A method comprising: forming at least computing nodes on a substrate by, for each of the computing nodes on the substrate, forming one or more processors, memory, and a wireless or optical communication unit on the substrate; forming for one or more wireless or optical cavities around at least some of the computing nodes on the substrate such that each of the one or more wireless or optical cavities reduces signal attenuation for signals transmitted by at least one transmitting component of each computing node within the wireless or optical cavity, wherein at least some of the computing nodes are configured to be associated with a first layer of a neural net, and at least some of the computing nodes are configured to be associated with a second layer of the neural net, wherein, for each of at least some of the computing nodes, the one or more processors of the computing node are configured to (i) wirelessly or optically transmit signals to other ones of the computing nodes via the wireless or optical communication unit of the computing node and (ii) wirelessly or optically receive signals from other ones of the computing nodes via the wireless or optical communication unit of the computing node.

What is claimed is:

1. A computer system for facilitating wireless or optical communication between computing nodes of a neural net, the computer system comprising:
at least 1,000 computing nodes,
wherein at least some of the 1,000 computing nodes are configured to be associated with a first layer of a neural net, and at least some of the 1,000 computing nodes are configured to be associated with a second layer of the neural net,
wherein the 1,000 computing nodes each comprise (i) one or more processors, (ii) memory, and (iii) a wireless or optical communication unit,
wherein, for each of the 1,000 computing nodes: the one or more processors, the memory, and the wireless or optical communication unit of the computing node are on-die components of the computing node, and
wherein, for each of the 1,000 computing nodes, the one or more processors of the computing node (i) wirelessly or optically transmit signals to other ones of the 1,000 computing nodes via the wireless or optical communication unit of the computing node and (ii) wirelessly or optically receive signals from other ones of the 1,000 computing nodes via the wireless or optical communication unit of the computing node.

2. The computer system of claim 1, further comprising a container, wherein each of the 1,000 computing nodes is within the container.

3. The computer system of claim 1, further comprising one or more wireless or optical cavities, wherein each of the one or more wireless or optical activities are placed around at least a different subset of the 1,000 computing nodes, and wherein each of the one or more wireless or optical cavities are configured to reduce signal attenuation for signals transmitted by at least one transmitting component of each computing node within the wireless or optical cavity.

4. The computer system of claim 3, wherein, for at least one computing node within each of the one or more wireless or optical cavities, at least one wireless-or-optical-signal transmitting component of the at least one computing node extends beyond an outer surface of the wireless or optical cavity.

5. The computer system of claim 4, wherein the one or more processors of the at least one computing node are configured to communicate with the one or more processors of at least one other computing node within at least one other one of the one or more wireless or optical cavities via the at least one wireless-or-optical-signal transmitting component of the at least one computing node that extends beyond the outer surface of the wireless or optical cavity.

6. The computer system of claim 1, wherein, for each of the 1,000 computing nodes, the one or more processors of the computing node directly transmit signals to other ones of the computing nodes via the wireless or optical communication unit of the computing node without an intermediary between the computing node and the respective other computing node passing the transmitted signal to the respective other computing node.

7. The computer system of claim 1, wherein, for each of the 1,000 computing nodes, the one or more processors of the computing node directly receive signals from other ones of the computing nodes via the wireless or optical communication unit of the computing node without an intermediary between the computing node and the respective other computing node passing the received signal to the other computing node.

8. The computer system of claim 1, wherein the first layer is an input layer of the neural network, and the second layer is an output layer of the neural network,
wherein training information is provided to one or more computing nodes associated with the input layer of the neural net to train the neural net, and
wherein one or more results are provided by one or more computing nodes associated with the output layer of the neural net.

9. The computer system of claim 1, wherein the wireless or optical communication unit for each of at least some of the 1,000 computing nodes comprises a wireless communication unit, the wireless communication unit including a radio frequency transceiver and an antenna.

10. The computer system of claim 1, wherein the wireless or optical communication unit for each of at least some of the 1,000 computing nodes comprises an optical communication unit, the optical communication unit including an optical transceiver.

11. A computer system for facilitating wireless or optical communication between computing nodes of a neural net, the computer system comprising:
a plurality of computing nodes;
one or more wireless or optical cavities, wherein each of the one or more wireless or optical activities are placed around at least a different subset of the computing nodes, and wherein each of the one or more wireless or optical cavities are configured to reduce signal attenuation for signals transmitted by at least one transmitting component of each computing node within the wireless or optical cavity,
wherein at least some of the computing nodes are configured to be associated with a first layer of a neural net, and at least some of the computing nodes are associated with a second layer of the neural net,
wherein the computing nodes each comprise (i) one or more processors, (ii) memory, and (iii) a wireless or optical communication unit,
wherein, for each of the computing nodes: the one or more processors, the memory, and the wireless or optical communication unit of the computing node are on-die components of the computing node, and
wherein, for each of the computing nodes, the one or more processors of the computing node (i) wirelessly or optically transmit signals to other ones of the computing nodes via the wireless or optical communication unit of the computing node and (ii) wirelessly or optically receive signals from other ones of the computing nodes via the wireless or optical communication unit of the computing node.

12. The computer system of claim 11, further comprising a container, wherein each of the computing nodes is within the container.

13. The computer system of claim 11, wherein, for at least one computing node within each of the one or more wireless or optical cavities, at least one wireless-or-optical-signal transmitting component of the at least one computing node extends beyond an outer surface of the wireless or optical cavity.

14. The computer system of claim 13, wherein the one or more processors of the at least one computing node are configured to communicate with the one or more processors of at least one other computing node within at least one other one of the one or more wireless or optical cavities via the at least one wireless-or-optical-signal transmitting component of the at least one computing node that extends beyond the outer surface of the wireless or optical cavity.

15. The computer system of claim 11, wherein, for each of the computing nodes, the one or more processors of the computing node directly transmit signals to other ones of the computing nodes via the wireless or optical communication unit of the computing node without an intermediary between the computing node and the respective other computing node passing the transmitted signal to the respective other computing node.

16. The computer system of claim 11, wherein, for each of the computing nodes, the one or more processors of the computing node directly receive signals from other ones of the computing nodes via the wireless or optical communication unit of the computing node without an intermediary between the computing node and the respective other computing node passing the received signal to the other computing node.

17. The computer system of claim 11, wherein the first layer is an input layer of the neural network, and the second layer is an output layer of the neural network,
wherein training information is provided to one or more computing nodes associated with the input layer of the neural net to train the neural net, and
wherein one or more results are provided by one or more computing nodes associated with the output layer of the neural net.

18. The computer system of claim 11, wherein the wireless or optical communication unit for each of at least some of the computing nodes comprises a wireless communication unit, the wireless communication unit including a radio frequency transceiver and an antenna.

19. The computer system of claim 11, wherein the wireless or optical communication unit for each of at least some of the computing nodes comprises an optical communication unit, the optical communication unit including an optical transceiver.

20. A method of forming neural net computing nodes configured to wirelessly or optically communicate with one another, the method comprising:
forming at least 1,000 computing nodes on a substrate by, for each of the 1,000 computing nodes on the substrate, forming one or more processors, memory, and a wireless or optical communication unit on the substrate;
forming for one or more wireless or optical cavities around at least some of the 1,000 computing nodes on the substrate such that each of the one or more wireless or optical cavities reduces signal attenuation for signals transmitted by at least one transmitting component of each computing node within the wireless or optical cavity,
wherein at least some of the 1,000 computing nodes are configured to be associated with a first layer of a neural net, and at least some of the 1,000 computing nodes are configured to be associated with a second layer of the neural net, and
wherein, for each of at least some of the 1,000 computing nodes, the one or more processors of the computing node are configured to (i) wirelessly or optically transmit signals to other ones of the computing nodes via the wireless or optical communication unit of the computing node and (ii) wirelessly or optically receive signals from other ones of the computing nodes via the wireless or optical communication unit of the computing node.
